(19) United States
(12) Patent Application Publication
(10) Pub. No.: US 2010/0057501 A1
(43) Pub. Date: Mar. 4, 2010

(54) IN-ROOM GUEST INTERACTIVE SYSTEM

(76) Inventor: Azmat Mohammed, Manchester (GB)

Correspondence Address: BLANK ROME LLP, ONE LOGAN SQUARE, PHILADELPHIA, PA, 19103, US

(21) Appl. No.: 12/549,055

(22) Filed: Aug. 27, 2009

Related U.S. Application Data
(63) Continuation-in-part of application No. 12/466,132, filed on May 14, 2009.
(60) Provisional application No. 61/127,835, filed on May 14, 2008.

(51) Int. Cl. G06Q 50/00; G06Q 10/00; G06Q 30/00; G06F 15/16; G06F 3/048

(52) U.S. Cl. 705/5; 705/26; 709/206; 715/760

(57) ABSTRACT

The present invention provides a compelling new guest facing interactive system. Screens displaying a virtual desktop application that sits in rooms allowing guests to interactively browse and book services at leisure. The system carries rich content including video. It can be configured to provide traditional room services and also excursions and activities provided by external providers. It can also be integrated with mobile phone.

### RELATED APPLICATIONS

This application in a continuation-in-part of U.S. patent application Ser. No. 12/466,132, filed on May 14, 2009, which claims priority to U.S. Provisional Application No. 61/127,835. These applications are herein incorporated by reference in their entirety.

### FIELD OF THE INVENTION

This invention relates to a guest facing interactive system. Particularly, a new guest facing interactive system that has interactive terminals placed in hotel rooms that allow direct interaction with hotel guests to deliver rich content and services.

### BACKGROUND OF THE INVENTION

The phenomenal growth of tourism worldwide prompts the increasing number of first class and luxury hotel construction projects worldwide. Globally, number of luxury hotel is increasing rapidly. The number of first class and luxury hotels worldwide is increasing by 7.1 percent, which means more than 2,570 hotels and resorts. There are estimated 862 hotel projects in Europe, of which 282 are luxury hotels, 580 are first class hotels. In Germany, Austria and Switzerland alone, there are over 400 projects. There are 557 hotel projects in North America and the Caribbean, of which 224 are luxury hotels, 333 are First class hotels. There are 649 hotel projects in Asia and Pacific region, of which 382 are luxury hotels, and 267 are First class hotels. There are 309 hotel projects in the Middle East, of which 214 are luxury hotels, and 95 are First class hotels. Taken the United Arab Emirates as an example, the opening of the Atlantis resort in Dubai (1,529 rooms) end of September 2008 marks the completion of only one hotel project of nearly 100 in the United Arab Emirates. Within the next five years, approx 42,000 rooms will be added to the first class and luxury hotel market of Dubai. The number of leading hotels grows by 21 percent which is more than any other region of the world.

Hotels, especially luxury hotels, strive to continue improving the guest experience and setting the hotel apart from the competition. There exists a need for an in room concierge system that interacts with the guests through rich media, and provides the guest a wide variety of services provided by the hotel and also by external vendors.

### BRIEF DESCRIPTION OF THE DRAWINGS

The present invention will be better understood with reference to the following description taken in combination with the drawings. For the purpose of illustration, there are shown in the drawings certain embodiments of the present invention. In the drawings, like numerals indicate like elements throughout. It should be understood, however, that the invention is not limited to the precise arrangements, dimensions, and instruments shown. In the drawings:

FIG. 1 is an illustration of an exemplary deployment of the present invention system in a hotel setting;

FIG. 2 illustrate the components and data flow of another exemplary deployment of the present invention;

FIG. 3 is an illustration of the functional components of the present invention system;

FIG. 4 is a representative screen display of the present invention system welcome screen;

FIG. 5 is a representative screen display of the present invention system for a guest to select a category of desired room service;

FIG. 6 is a representative screen display of the present invention system for a guest to select a desired room service;

FIG. 7 is a representative screen display of the present invention system displaying details of a selected room service;

FIG. 8 is a representative screen display of the present invention system for a guest to order a selected room service;

FIG. 9 is a representative screen display of the present invention system of a checkout screen for a guest to order a selected room service;

FIG. 10 is a representative screen display of the present invention system guest ordered room services viewed by a hotel staff;

FIG. 11 illustrates an example of the integration of present invention to a mobile phone system; and

FIGS. 12A-E are representative screen displays of the present invention system where a guest orders an excursion and receives e-ticket and itinerary on her mobile phone.

### SUMMARY OF THE INVENTION

The present invention provides an interactive information, reservation and purchasing system, comprises a plurality of user interface devices, wherein the a user of the interactive reservation system can use to make reservations or purchases of services or products desired, and a server system connecting to the plurality of user interface devices, wherein the server system provides an interactive user interface to be displayed on the plurality of user interface devices, and provides updates of the services and products available to the user of any one of the plurality of user interface devices.

According to one aspect of the present invention, each of the plurality of user interface devices has a touch screen.

According to one aspect of the present invention, each of the plurality of user interface devices is thin clients.

According to one aspect of the present invention, each of the plurality of user interface devices is a wireless device.

According to one aspect of the present invention, each of the plurality of user interface devices is located in hotel guest rooms.

According to another aspect of the present invention, the server system further connects to a plurality of third party vender systems, wherein the third party vender systems provides additional services and products available to the user of any one of the plurality of user interface devices.

According to one aspect of the present invention, the server system connects to a media library that provides audio, video media, and advertising content.

According to one aspect of the present invention, the server system interfaces with a property management system.

According to one aspect of the present invention, the server system has access to hotel booking and client information.

According to one aspect of the present invention, the server system interfaces with other hotel software such as spa software

According to one aspect of the present invention, the server system interfaces with a mobile gateway.

According to one aspect of the present invention, the server system delivers information to a mobile phone through the mobile gateway.

According to one aspect of the present invention, the plurality of user interface devices comprises at least one mobile phone.

According to one aspect of the present invention, the system further comprises at least one administrative terminal, wherein the administrative terminals may be used to configure and modify the server system.

According to one aspect of the present invention, the server system further comprises an administration and reporting module.

According to one aspect of the present invention, the server system further comprises at least one failover server.

According to one aspect of the present invention, the server system further comprises a web server.

According to one aspect of the present invention, the interactive user interface is in the form of a webpage that can be displayed in a web browser.

According to one aspect of the present invention, the interactive user interface is in the form of a desktop application.

### DETAILED DESCRIPTION OF THE INVENTION

The in-room guest interactive system of the present invention is also referred to interchangeably as the RoomConcierge system. RoomConcierge is a compelling new guest facing interactive system. It provides screens displaying a virtual desktop application that sits in guest rooms allowing guests to interactively browse and book services at leisure. The system will carry rich content including video. It will be a market leader with a product that has no competitor and offers new levels of convenience and luxury whilst delivering substantial financial returns. Key Features of the RoomConcierge system includes, but are not limited to, it pulls together all the facilities of a hotel into an In-Room Console; offers guests a whole new level of convenience and luxury; guests can book internal services and services provided by external partners; it delivers rich content and an elegant intuitive graphical user interface (GUI), which will drive revenues substantially. It also provides an innovative and robust technology platform with multiple hardware options and mobile integration. The system also features quick and low cost integration into PMS and infrastructure (new hotels and retrofit of existing hotels), and a rapidly scalable business model. There is no proven competitor, which provides any hotel that deploys the present invention the opportunity to become a market leader in a large emergent market.

The present invention RoomConcierge system allows guests to fully explore the hotel facilities and selected local attractions. It can appeals to business customers, leisure travelers and families. It seamlessly integrates with existing hotel PMS systems such as PROTEL, Softbrands PMS, Micros, FIAS spec systems and others, mobile phone networks and external partner vendors. It can be customized to the requirements of any hotel. It also can compliment existing décor of a hotel. It also connects to other hotel software such as Premier Spa.

The present invention RoomConcierge system adds value and prestige to existing room facilities. It maximizes the use of hotel facilities and increases their revenue streams, and gains new revenue streams by facilitating bookings for local events and attractions. It also acquires a unique selling point to attract new customers and retain existing customers. It further reduces routine guest enquiries and save valuable staff time. It distinguishes the hotel from the competition. It also increases customer satisfaction by empowering guests to make the most of their stay at your hotel. It facilitates cross-selling of other hotels and services, and enhances the reputation of the hotel as an exceptional and innovative hotel.

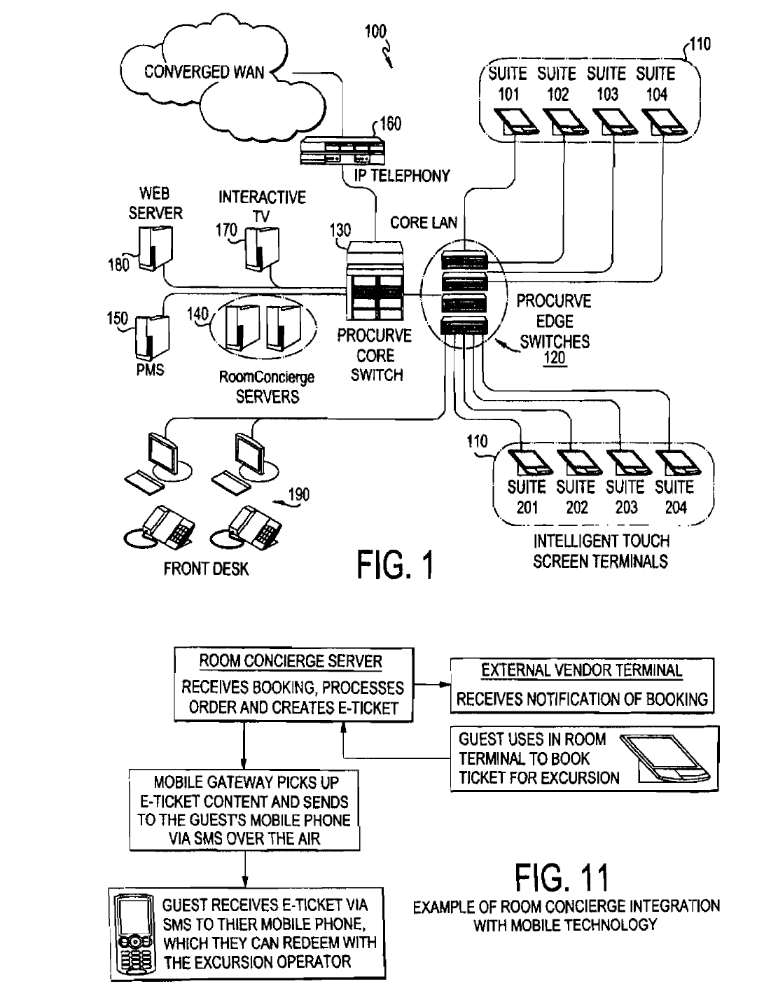

FIG. 1 illustrates an exemplary deployment of the present invention system 100 in a hotel setting. The present invention system may also be deployed in serviced apartments, cruise ships, and maybe scaled up or down to accommodate the needs for any hospitality business. The system may include a plurality of intelligent terminals 110 placed in guest rooms or any other locations on the hotel premises. The plurality of intelligent terminals 110 are connected to a network infrastructure. In this particular example, the plurality of intelligent terminals 110 are connected to a number of network switches 120. The network switches further connects to a core switch 130. In this example, a Procurve® core switch. The particularities of a network infrastructure may vary from implementation to implementation, and can use any hardware suitable for such purpose. One or more RoomConcierge servers 140 are connected to the core switch 130. The system may connect to a hotel's existing property management system (PMS) 150. The system may also include hardware interface for IP telephony 160 that connects to the network infrastructure through the core switch 130. In addition, interactive TV service 170 and one or more web servers 180 may also be included in the system. Administrative terminals 190 maybe placed at the front desk of the hotel and any other administrative locations. Network connections among of the components of the present system may employ existing technology well known to one person skilled in the art, for example, without limitation, wired Ethernet connections (10/100/Gigabit), fiber optic connections, and/or wireless connections.

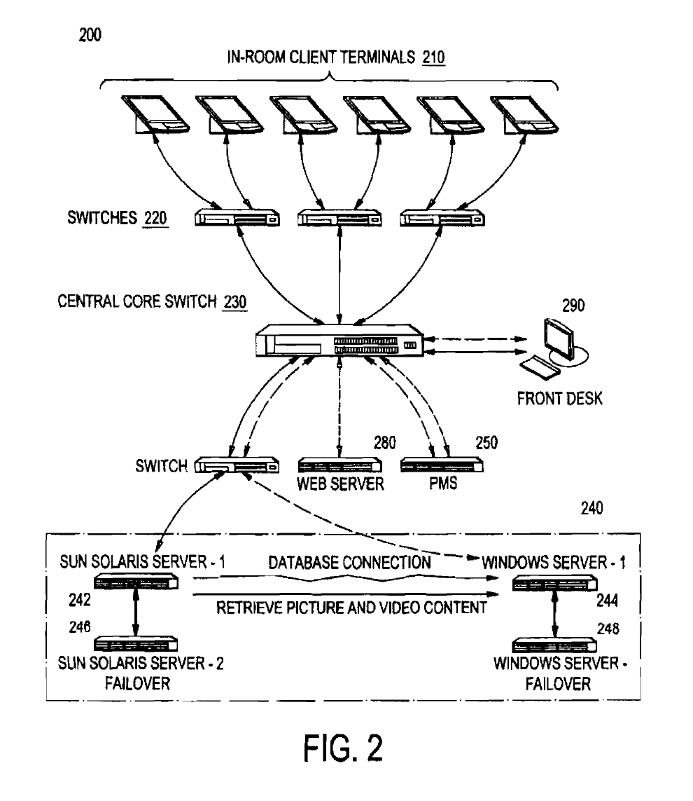

FIG. 2 illustrates the components and the data flow of another exemplary deployment of the present invention. Similar to the example in FIG. 1, the system 200 in FIG. 2 also comprises a plurality of client terminals 210, a number of switches 220, and a central core switch 230. The system 200 also may include one or more web servers 280, and PMS server 250. One or more administrative terminals 290 are locate at any administrative locations, such as the front desk, to allow hotel employees access to the system 200. In this particular example, the RoomConcierge Servers 240 comprises two servers which are referred to for convenience only as Sun Solaris Server-1 242 and Windows Server-1 244. The particular hardware and software for the implementation is the described functionality of the RoomConcierge Server 240 can be varied as known to one skilled in the art, and are not limited to the particular hardware and software combination described. In this particular example, two additional servers, referred to for convenience only as Sun Solaris Server-2 246 and Windows Server-2 248, are included in the system 200 as a failover server in case of the failure of any one of the RoomConcierge Servers 242 244. Arrows in the figure indicates the direction of data transmission.

The present invention RoomConcierge system has been developed in such a way that it is compatible with all standard display hardware as the client terminals. Without limitation, there are a number of options regarding how this equipment could be implemented.

a) A thin client display unit—This type of display hardware has no operating system or software installed. When a user starts the system the thin client identifies the user to the server and the server displays the desktop or application, in this case, RoomConcierge interface to the client. In many cases, thin Client hardware has no means of data storage hence the unit is virtually immune to virus or service attacks and there is no way for users to extract/remove data from the client thus giving a secure standalone unit.

A standard network client—This would in most cases be a standard client PC accessing the RoomConcierge application via HTTP across a Local Area Network. On starting the hardware the client would access the application server and interact with the application in much the same way as it would a standard website.

With both the thin and standard client implementations there are further options to be considered. RoomConcierge has been designed so that it is suitable for use with Touch screen technology as a method of user input and interaction as well as the standard keyboard and mouse method. Also the availability of Wireless LANs in some hotels would allow the use of wireless devices.

As one preferred embodiment, the RoomConcierge may use the Sunray 270 (SR270) virtual display clients as the in-room terminal. The in-room terminals, which may also be referred to as the client terminals, situated inside the guest bedrooms will be Sunray 270 virtual display clients.

The SR270 is a thin client and therefore has no operating system or software installed. It also has no means of data storage hence the unit is virtually immune to virus or service attacks and there is no way for users to extract/remove data from the client thus giving a secure standalone unit.

The SR270 has a standard keyboard and mouse attached to it and plugs straight into the wall jack allowing access to the in-house Local area network.

The client unit gains access to the network and its prescribed virtual desktop using instant-on smart cards. The smart card identifies the user to the server and the server displays the desktop or application, in this case, room-concierge to the client. The clients will be connected to the server over a 10/100 copper Ethernet connection.

If the location for RoomConcierge has a multi level network infrastructure, then switches may be used to connect the client terminals on network segments, such as each floor of a multi-story build, to the LAN. An additional switch will be added to connect the RoomConcierge servers to the core switch. Switches help to increase the speed of traffic on a network and help to main a full duplex Ethernet, i.e., data can be transmitted in both directions simultaneously.

The Room-Concierge system comprises RoomConcierge Servers. In a typical deployment of the present invention, the RoomConcierge Servers has a backbone of at least 2 servers (main servers) with an additional 2 failover servers. The failover servers will take over from the main server upon failure or abnormal termination of the main server. This is done without human intervention and provides the network with a high degree of reliability and continuous availability. Alternatively the servers can be located in a remote location and accessed via a secure network.

The first of the 2 main servers is referred to for convenience only as the ‘Sunray’ Server. In this particular example, it has the ‘Sun Solaris’ operating system installed and Sunray server, to allow for kiosk mode. The ‘Sun Solaris’ OS is Unix based. The server will have ‘Sun Server Software’ installed which is the software which delivers the virtual desktop to the client. The virtual desktop will be running Mozilla Firefox in kiosk mode. This will appear to the user in full screen with no ability to revert back to the desktop on the server. This server holds only the web pages used to view the RoomConcierge application and will have PHP installed. A summary of software installed on server-1 includes, but are not limited to, Sun Solaris OS, Sunray Server Software, Mozilla Firefox, PHP 5.1, Apache server, and RoomConcierge.

The second main server is referred to for convenience only as a windows based server. In this particular example, the OS will be windows server 2003 or 2008. The purpose of this server is to hold both the database for the system and also the middleware which will in turn access the PMS system to record bookings and gather client information. The data on the server will be held in a database, such as MYSQL. This server will also hold the video and picture content for the RoomConcierge application. The video will be streamed to the guest rooms, for example, using flash media server, which will be installed on this server. A summary of software on server-2, includes, but are not limited to, Windows server 2003/2008, MYSQL, Toad for MYSQL admin, RoomConcierge Admin tool, Flash Media Server, SwifiFias middleware application (supplied by 3rd party).

In a preferred embodiment, the RoomConcierge system will be a browser based application written in PHP using a MYSQL database. The application will run in Mozilla Firefox, in kiosk mode, and will be accessed via the smart cards on the virtual display clients situated inside the guest bedrooms.

In this embodiment, the GUI will access the database in order to decide which menu options should be displayed and which video/pictures/content should be displayed inside of each menu option. The database can be administrated inside the host location or externally. There will be administrator section to the system that allows for the upload of new video and picture content. The system also allows for the updating of prices within the system and the addition of new products and services that the location can offer its guests. The admin section will reside on the windows server.

In this embodiment, there will be 2 MySQL databases on the windows server. The first one, ‘swififias’ will be used by both the middleware application which transmits the orders from the client to the PMS system. The second ‘RoomCon’ will be the database which holds the definition for each of the screens that will be displayed in the application as well as recording information for statistical and reporting purposes.

When a guest decides they wish to book one of the options available, the system will post a charge record to the ‘swififias’ database. The middleware, which polls this database every 2 seconds, will in turn transmit this data to the PMS system in order that the guest's room can be charged for the ordered item. The middleware will then record the outcome of this posting back to the ‘swififias’ database and the room-concierge system in turn and relay the results back to the user to confirm their booking has been accepted. Bookings may be rejected, for example, if the guest has exceeded their credit limit.

As the PMS system is external to the RoomConcierge system and can on occasion be non functional for offline for a period of time, the middleware will continue to transmit the data to the PMS system until it receives a response. This ensures that even though the PMS may be offline, no bookings will be missed.

In this embodiment, there will be a reporting facility available which will provide management with reports on such things as: usage per guest room, most viewed items, most ordered items, peak viewing times, peak ordering times, status of the servers and other useful stats that will enable system administrators to best exploit the system to provide guests with an optimized system and relevant content.

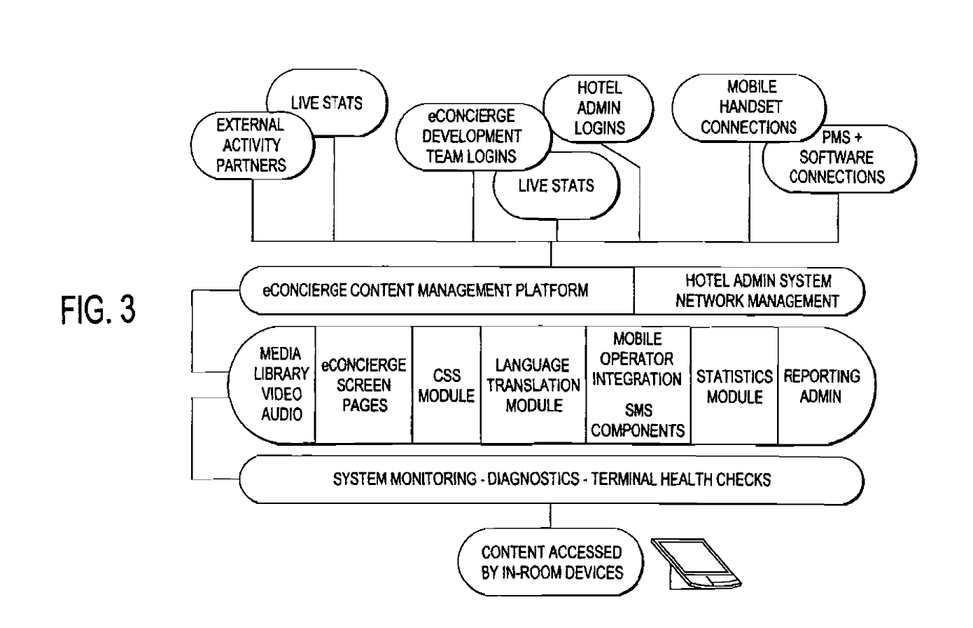

FIG. 3 illustrates the functional components of the present invention system. The system comprises a content management platform, a hotel admin system and network management system. The content management system together with the admin system and network management systems connect to external activity partners, provides live stats, development team logins, hotel admin logins, mobile handset connections, and PMS software connections. The content management system further connects to Media library for video and audio contents, hosts RoomConcierge screen pages, and also interacts with CSS modules, mobile operator integration and SMS components, statistics module, and reporting admin functionality. The system also includes functionality for system monitoring, diagnostics, and terminal health checks.

In terms of the ordering and booking of Room Service, Spa Treatments and Excursions the present invention system uses a familiar shopping basket metaphor to make the process of ordering and booking items and services as straightforward and hassle free as possible.

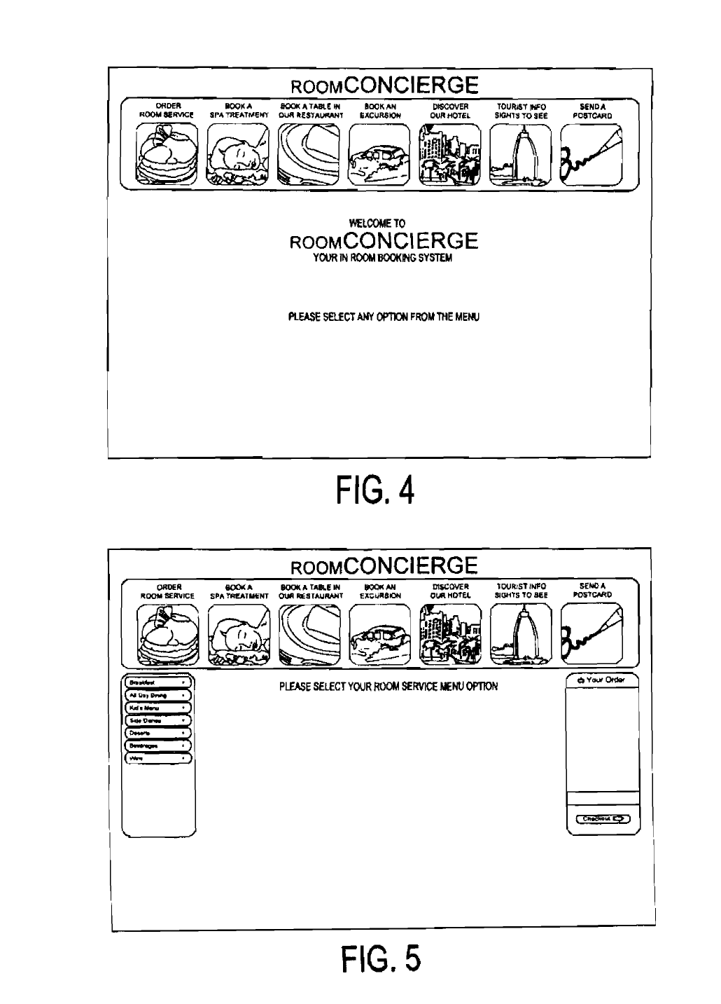

When a user starts RoomConcierge they will see a screen similar to the one shown in FIG. 4. This screen will offer the user a number of sections to browse ranging from Room Service and Spa treatments to Tourist Information on the locale and sending an e-postcard.

If, for example, a guest wished to order breakfast using Room Concierge they would click the Room Service button on this page. This would then take them to the Room Service section where they can browse and order anything from the menu.

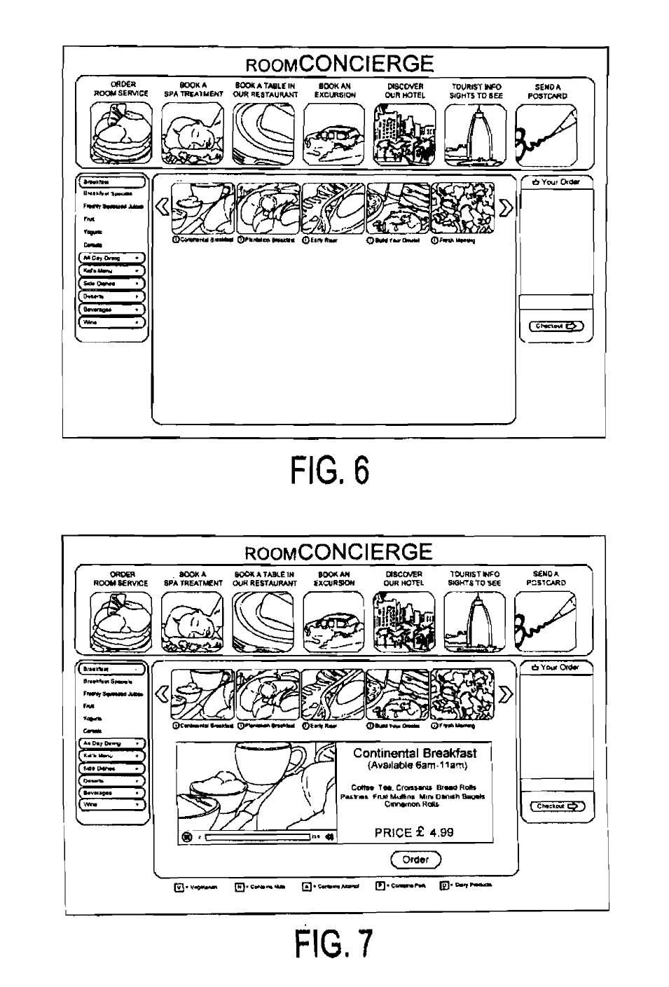

On arriving at the Room Service section they will be presented with the screen shown in FIG. 5. Here, they would make a choice regarding what type of thing they would like to order. In this example, they would click the Breakfast option on the menu which would reveal the different Breakfast options available room service menu (FIG. 6).

To view the details of each of the products (breakfasts in this case) by clicking the products button as shown in FIG. 7. Here the guest can see a video of the dish being made by the chef as they tell the guest a little bit about the dish/ingredients. Also on this screen are details regarding what is included in the dish, when it is available to order, the price, and dietary information (e.g., suitable for vegetarians etc).

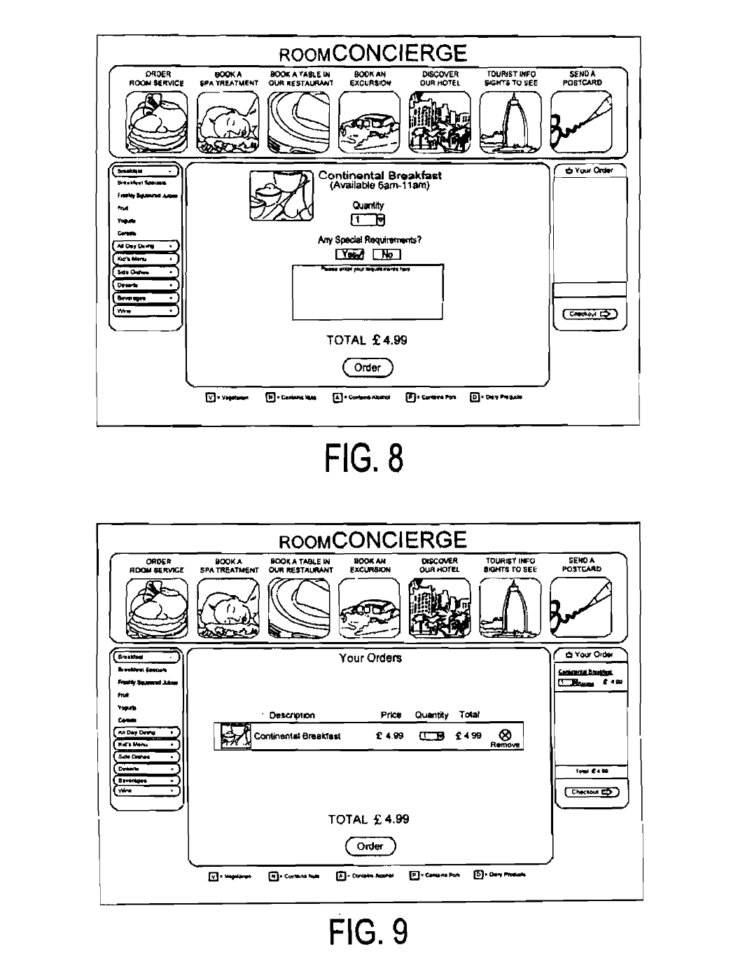

If the guest decides this is an item they would like to order they should click the order button on this screen. When they click the order button this should open the order details screen (FIG. 8).

Here the user can confirm their order and enter specific information regarding this particular part of their order, including quantity and any special requirements they might have.

If the guest is happy with these details and would like to confirm the order they would press the Order button to add the order to the Shopping Basket.

The Shopping Basket is visible on every screen and at a glance shows the guest: items ordered, quantity of ordered items, price of each of the ordered items, and total amount of the order.

The shopping basket also allows the user to make adjustments to their order. From the Shopping Basket a guest can: review their order, remove items from the basket, and change the quantity of ordered items.

When a guest clicks the Checkout button located at the bottom of the Shopping Basket, it will open the Checkout Screen as shown in FIG. 9.

The Checkout screen lists the ordered items and their associated details regarding unit price, quantity, product total price. It also shows the Total amount for the order. To complete the order and submit it for processing the user clicks the Order button.

When this has been clicked, RoomConcierge adds the order to the RoomCon database and charges the guest either by adding the charge directly to their room bill or by offering a credit card payment option.

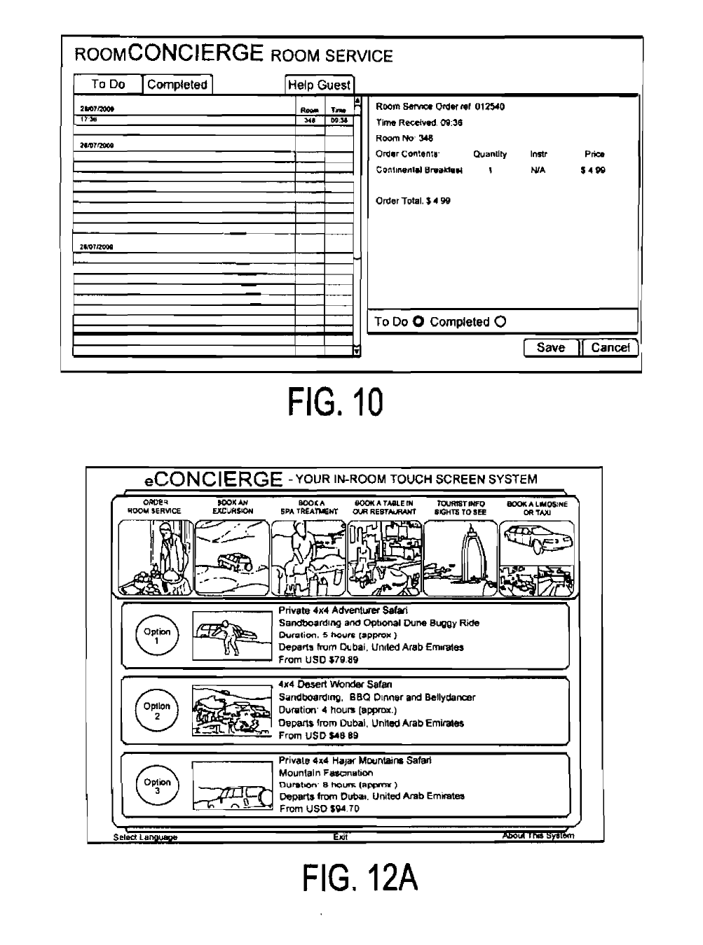

When the order has been added to the database it will show up in the administrator section for processing (FIG. 10).

Orders in the admin section are divided into two areas; To Do (incomplete orders—e.g., a guest has ordered room service but this order hasn't yet been delivered to the room), and completed (orders that have been delivered) and will appear on the respective screen ordered by the time and date of there arrival on the system. When an order comes into the system it is marked as To Do and will appear on the To Do screen in the admin section.

To process an order an administrator or member of hotel staff would click the order entry in the To Do pane on the left hand side of the screen to view the order details in the right hand pane. Once the order has been delivered, the member of staff can click the Completed radio button in the right hand pane which sets its status as Complete and moves it from the To Do screen to the Completed screen.

Another key feature is the remote help function. This function allows guests to request remote online help using Room Concierge. On the guest facing side of the system there is a Help! button at the bottom of each screen. If a user clicks this and confirms they need help using the system this creates a notification which is sent to the administration screen informing the system administrator that a user at a particular location requires help. The administrator can then phone the user while connecting remotely to the user's session on RoomConcierge and offer help and guidance using the system. From the administration point of view this functionality all resides in the admin section under the Help Guest tab.

Help notifications will appear live in the To Do screen so calls for help can be acted on immediately and will not be missed due to admin users not refreshing the screen frequently. The notification will be time stamped and will include the location id (e.g., Room number). The admin user would then click the Help guest tab. Here the admin user has a mobile phone-like interface with a keypad to enter the location id and a connect button to initiate the remote connection. The admin user would then view the remote session on their desktop and guide the guest through the system by taking control of the guest's session. When the admin user has solved the guest's issue they close the remote session window which terminates the remote session.

A further example of how Room Concierge will be used from a guest point of view would be Express Check out. In the event of a guest wishing to checkout of their room quickly, they can select the Express Checkout option from Room Concierge. Room Concierge will then pull the billing information back for all orders associated with that reservation and present the guest with the total amount to be billed. The guest will also be given an option to approve the transaction. If they choose to approve the transaction the guest will be billed the approved amount via the PMS and they will be free to leave the hotel. If they wish to query the bill they can request a callback from the Concierge to discuss this in person.

The present invention RoomConcierge system maybe integrated with mobile phone systems. Mobile phone integration may be implemented to support the booking of excursion tickets through Room Concierge. For example, hotel guests will be able to browse and book a range of excursions from the Room Concierge system. When a guest has chosen a particular excursion and orders it, the order will be added to their room bill via the PMS. Once the order has been added to the PMS, Room Concierge will send an e-ticket with a booking reference number to the guest via SMS via a Mobile Gateway, which they can then redeem with the excursion operator. The excursion operator is also sent confirmation of the booking. This is possible via a number of methods including automated email or SMS or secure web service. There are options with this feature to offer billing for e-tickets via mobile handset credit card billing and premium SMS.

FIG. 11 illustrates an exemplary implementation of the mobile phone integration. In this example, a guest uses an in room terminal to book a standard or e-ticket for an excursion. The RoomConcierge server receives booking, processes order and creates e-ticket. The RoomConcierge server then sends notification of booking to external vendor's terminal. The RoomConcierge also send the e-ticket to the guest's mobile phone via SMS over the air through a mobile gateway. The guest then receives the e-ticket via SMS to their mobile phone, which she can redeem with the excursion operator.

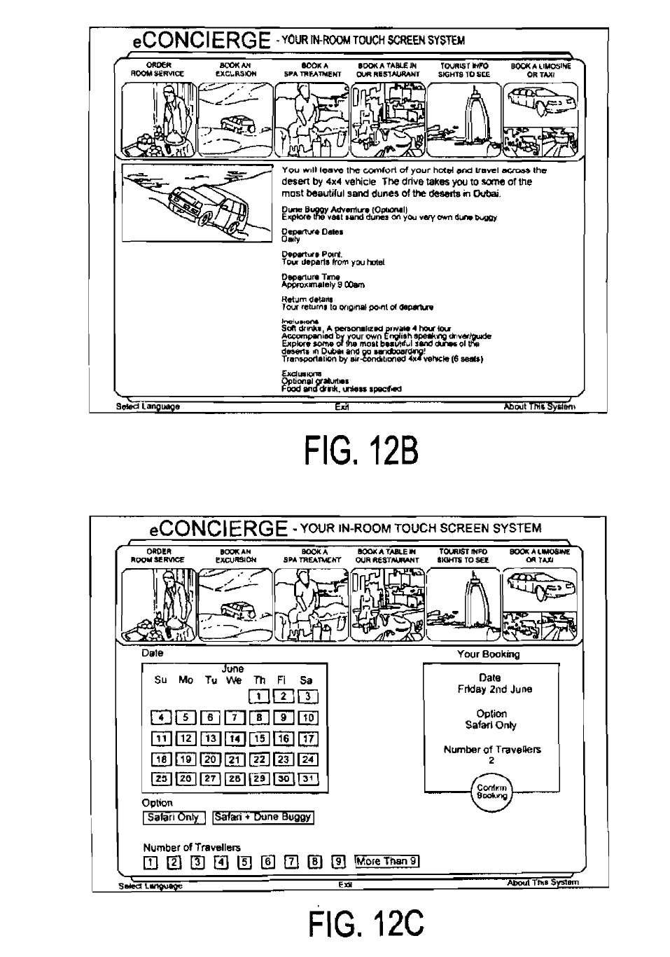

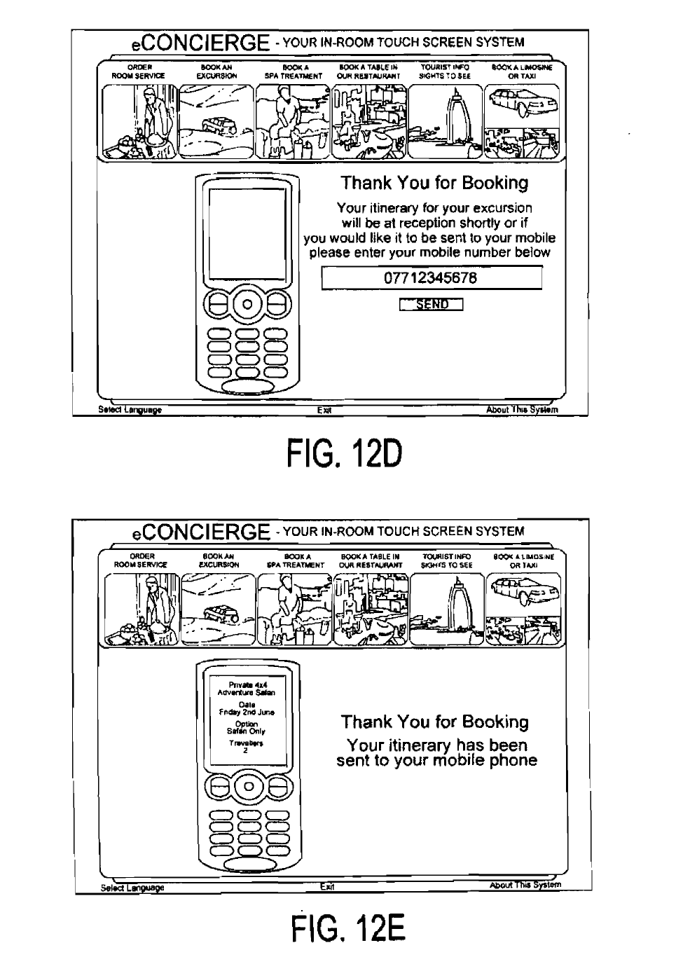

Excursions, activities and products provided by external providers can also be presented through the RoomConcierge in-room terminal to a guest, these can also be in the form of a display advert. The presentation and ordering of the excursions and activities provided by external providers are the same as the room service as outlined above. Revenue from the excursions and activities provided by external providers can be shared by the hotel and the external providers. FIGS. 12A-E illustrate an example of ordering an excursion through the RoomConcierge system, wherein the e-ticket and itinerary of the excursion is directly send to the guest's mobile phone.

In addition to the GUI the hotel guests would interact with, Room Concierge will have an Administration section that will allow system administrators and management to monitor and administer changes to the system.

The administration application will be mostly written in PHP, connecting to the RoomCon MySQL database (other technologies could also be used here such as Microsoft's .Net Framework, MSSQL and Java). AJAX will be used to facilitate the asynchronous functionality (live updating of screens without refreshing the page). This will allow administrators to manage all the content on their system.

The present invention RoomConcierge may also provide features like Track RoomConcierge usage, Manage RoomConcierge content and instant updates. The admin section will also give administrators and management a live view of the various types of orders (Room service, Spa treatments, excursions etc) that are coming through the system and confirmation of their subsequent completion. This section will also allow administrators to change or amend orders as necessary. For example administrators will be able to: Edit price or details of a particular product, Add products, Delete products, Turn products on/off (products that are only available at certain times), Change video and image content, Monitor incoming and complete orders, and Amend orders. This is all done via a simple, easy to use GUI, requiring no technical experience or expertise.

A key feature of RoomConcierge will be the reporting facility, which will be available from within the administration section. All user activity in terms of what content has been viewed and when, which products have been ordered by whom and at what time, status of the servers etc is recorded and entered into the ‘RoomCon’ database. In turn the statistical reporting facility will provide management with reports on a range of key metrics such as: Total room service orders over a given time period, Room service orders by room over a given time period, Room service orders by product over a given time period, Total value of room service orders over a given time period, Product views (Room service, Spa treatments, excursions etc) over a given time period, Total number of user over a given time period, and Average length of user session.

The reports created will be presented in the form of graphs, pie charts and tables depending on the metrics selected for reporting within an easy to use GUI. This information will enable system administrators and management to best exploit the system to provide guests with an optimized system and relevant content.

Customers of Room Concierge will also benefit from around the clock system support. This will be made possible through the use of a master dashboard at Room Concierge HQ. From this dashboard, RoomConcierge support engineers will be able to connect to any RoomConcierge system in the world remotely and carry out software upgrades, system administration tasks, or assist local systems administrators. The dashboard may be built in Java.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. Specific dimensions of any particular embodiment are described for illustration purposes only. It should therefore be understood that this invention is not limited to the particular embodiments described herein, but is intended to include all changes and modifications that are within the scope and spirit of the invention.

What is claimed is:

1. A interactive information, reservation and purchasing system, comprising:
a plurality of user interface devices, wherein the a user of the interactive reservation system can use to make reservations or purchases of services or products desired; and
a server system connecting to the plurality of user interface devices, wherein the server system provides an interactive user interface to be displayed on the plurality of user interface devices, and provides updates of the services and products available to the user of any one of the plurality of user interface devices.

2. The interactive system of claim 1, wherein each of the plurality of user interface devices has a touch screen.

3. The interactive system of claim 1, wherein each of the plurality of user interface devices are thin clients.

4. The interactive system of claim 1, wherein each of the plurality of user interface devices are wireless devices.

5. The interactive system of claim 1, wherein each of the plurality of user interface devices are located in hotel guest rooms.

6. The interactive system of claim 1, wherein the server system further connecting to a plurality of third party vender systems, wherein the third party vender systems provides additional services and products available to the user of any one of the plurality of user interface devices.

7. The interactive system of claim 1, wherein the server system connects to a media library that provides audio, video media, and advertising content.

8. The interactive system of claim 1, wherein the server system interfaces with a property management system.

9. The interactive system of claim 8, wherein the server system has access to hotel booking and client information.

10. The interactive system of claim 1, wherein the server system interfaces with other hotel software such as spa software

11. The interactive system of claim 1, wherein the server system interfaces with a mobile gateway.

12. The interactive system of claim 11, wherein the server system delivers information to a mobile phone through the mobile gateway.

13. The interactive system of claim 1, wherein the plurality of user interface devices comprises at least one mobile phone.

14. The interactive system of claim 1, further comprises at least one administrative terminal, wherein the administrative terminals may be used to configure and modify the server system.

15. The interactive system of claim 14, wherein the server system further comprising an administration and reporting module.

16. The interactive system of claim 1, wherein the server system further comprising at least one failover server.

17. The interactive system of claim 1, wherein the server system further comprising a web server.

18. The interactive system of claim 17, wherein the interactive user interface is in the form of a webpage that can be displayed in a web browser.

19. The interactive system of claim 1, wherein the interactive user interface is in the form of a desktop application.
